(19) United States
(12) Patent Application Publication
(10) Pub. No.: US 2026/0008074 A1
(43) Pub. Date: Jan. 8, 2026

(54) TREATMENT LIQUID COATING APPARATUS AND METHOD OF CLEANING TREATMENT LIQUID COATING APPARATUS

(71) Applicant: SEMES CO., LTD., Cheonan-si, (KR)

(72) Inventors: Dae Sung KIM, Suwon-si (KR); Jae Ho LEE, Cheonan-si (KR); Nak Hyun SONG, Cheonan-si (KR); Jong Gu LEE, Sangju-si (KR)

(21) Appl. No.: 19/083,387

(22) Filed: Mar. 18, 2025

(30) Foreign Application Priority Data
Jul. 3, 2024 (KR) 10-2024-0087323

(51) Int. Cl. B05B 15/531; B05B 15/55

(52) U.S. Cl. CPC B05B 15/531; B05B 15/55

(57) ABSTRACT

A method of cleaning a treatment liquid coating apparatus, the method includes an operation of moving a spraying portion to a sucking position, an operation of discharging, by the spraying portion, a treatment liquid to the inside of a cleaning container in the sucking position, a first suck-back operation of suck-backing the treatment liquid remaining in the spraying portion, a first cleaning operation of cleaning an accommodation space of the cleaning container by supplying a preset supply amount of cleaning liquid, a second cleaning operation of cleaning a nozzle tip of the spraying portion by supplying a preset second supply amount of cleaning liquid, a second suck-back operation of suck-backing and moving the treatment liquid further backwards than in the first suck-back operation, and a third suck-back operation of suck-backing and moving the suck-backed treatment liquid further backwards than in the second suck-back operation.

### CROSS-REFERENCE TO RELATED APPLICATION(S)

This application claims benefit of priority to Korean Patent Application No. 10-2024-0087323 filed on Jul. 3, 2024 in the Korean Intellectual Property Office, the disclosure of which is incorporated herein by reference in its entirety.

### BACKGROUND

### 1. Field

The present disclosure relates to a treatment liquid coating apparatus and a method of cleaning the treatment liquid coating apparatus.

### 2. Description of Related Art

In general, a process of manufacturing a semiconductor substrate may be subdivided into a thin film process of depositing a thin film on a glass substrate, a photolithography process of forming the thin film to have a desired pattern, and an etching process of etching the thin film according to the pattern. The processes may be repeatedly performed, such that a semiconductor substrate may be manufactured.

A photoresist coating apparatus used in the photolithography process may spray a photoresist liquid through a nozzle connected to a photoresist supply source and coat the photoresist liquid on a surface of a loaded wafer. The sprayed photoresist liquid may be cured when a certain period of time has elapsed, and the wafer may be unloaded and transferred to a subsequent process.

The photoresist liquid may remain at a tip of a nozzle after the spraying of the photoresist liquid is completed. The remaining photoresist liquid, dropping on the surface of the wafer, may cause a development defect, which may adversely affect a subsequent process, and the photoresist solution remaining at the nozzle tip may be cured, causing an issue such as nozzle tip clogging or the like.

### PRIOR ART DOCUMENT

### Patent Document

Patent Document 1: Korean Patent Application No. 10-0980704 (Sep. 1, 2010)

### SUMMARY

An Aspects of the present disclosure provide a treatment liquid coating apparatus and a method of cleaning the treatment liquid coating apparatus, capable of not only eliminating the need to move a position of the nozzle in each of a cleaning operation and a suck-back operation when a nozzle tip and a homo pot is cleaned using a multi suck-back method in a photolithography process, but also preventing internal contamination of the nozzle tip during cleaning.

According to an aspect of the present disclosure, there is provided a method of cleaning a treatment liquid coating apparatus, the method including an operation of moving a spraying portion to a sucking position, an operation of discharging, by the spraying portion, a treatment liquid to the inside of a cleaning container in the sucking position, a first suck-back operation of suck-backing the treatment liquid remaining in the spraying portion, a first cleaning operation of cleaning an accommodation space of the cleaning container by supplying a preset first supply amount of cleaning liquid, a second cleaning operation of cleaning a nozzle tip of the spraying portion by supplying a preset second supply amount of cleaning liquid, a second suck-back operation of suck-backing and moving the treatment liquid further backwards than in the first suck-back operation, and a third suck-back operation of suck-backing and moving the suck-backed treatment liquid further backwards than in the second suck-back operation.

According to another aspect of the present disclosure, there is provided a treatment liquid coating apparatus including a spraying portion connected to a treatment liquid supply source through a supply line, the spraying portion including a nozzle tip from which the treatment liquid is discharged, and a discharge flow path extending at least partially from the inside of the nozzle tip, a suck-back portion disposed on the supply line, the suck-back portion positioned between the treatment liquid supply source and the spraying portion, the suck-back portion suck-backing the treatment liquid remaining in the discharge flow path, a cleaning unit disposed on a lower side of the spraying portion, the cleaning unit including a cleaning container having an open upper portion, the cleaning container having an accommodation space therein, a cleaning liquid supply portion connected to the cleaning container and supplying the cleaning liquid to the accommodation space, and a discharge portion disposed at a lower end of the cleaning container, the discharge portion communicating with the accommodation space to discharge the cleaning liquid, and a transfer unit connected to the spraying portion, the transfer unit raising and lowering the spraying portion such that the nozzle tip is at least partially accommodated in the accommodation space or the nozzle tip is withdrawn from the accommodation space. The cleaning liquid supply portion may be disposed between the nozzle tip and the discharge portion to supply the cleaning liquid into the accommodation space when the nozzle tip is accommodated in the accommodation space, may supply a preset first supply amount of cleaning liquid when the cleaning container is cleaned, and may supply a preset second supply amount of cleaning liquid, greater than the preset first supply amount of cleaning liquid, when the nozzle tip is cleaned.

According to another aspect of the present disclosure, there is provided a method of cleaning a treatment liquid coating apparatus, the method including an operation of lowering a spraying portion to a sucking position such that at least a portion of a nozzle tip of the spraying portion is accommodated in an accommodation space of a cleaning container, an operation of discharging, by the spraying portion, a treatment liquid into the accommodation space in the sucking position, a first suck-back operation of suck-backing the treatment liquid remaining in the spraying portion, a first cleaning operation of cleaning the accommodation space of the cleaning container by supplying a preset first supply amount of cleaning liquid, a second cleaning operation of cleaning a nozzle tip of the spraying portion by supplying a preset second supply amount of cleaning liquid, greater than the preset first supply amount of cleaning liquid, a second suck-back operation of suck-backing and moving the treatment liquid further backwards than in the first suck-back operation, a third suck-back operation of suck-backing and moving the suck-backed treatment liquid further backwards than in the second suck-back operation, a first discharge operation of discharging the cleaning liquid in the accommodation space, between the first cleaning operation and the second cleaning operation, a second discharge operation of externally discharging the cleaning liquid in the accommodation space, before the third suck-back operation, and an operation of raising the spraying portion to return to an original position thereof, after the third suck-back operation. In the first cleaning operation, when the cleaning liquid is filled into the accommodation space to reach a first liquid level and filled in the accommodation at the first liquid level, an end of the nozzle tip may be spaced apart from the cleaning liquid not to be in contact with the cleaning liquid. In the second cleaning operation, when the cleaning liquid is filled into the accommodation space to reach a second liquid level, higher than the first liquid level, and filled in the accommodation at the second liquid level, at least a portion of the nozzle tip may be immersed in the cleaning liquid.

In a treatment liquid coating apparatus and a method of cleaning the treatment liquid coating apparatus according to the present disclosure, a cleaning operation and a such-back operation may be performed in the same position without changing a position of a spraying portion. In addition, when a cleaning container and a nozzle tip are sequentially cleaned, a cleaning liquid used in such a process may all be discharged and a contamination prevention layer may be formed in the spraying portion, thereby preventing foreign substances from being introduced into the nozzle tip during cleaning.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a top view of a substrate treatment apparatus according to an example embodiment of the present disclosure;

FIG. 2 is a view of the substrate treatment apparatus of FIG. 1 in a direction of A-A;

FIG. 3 is a view of the substrate treatment apparatus of FIG. 1 in a direction of B-B;

FIG. 4 schematically illustrates a treatment liquid coating apparatus according to an example embodiment of the present disclosure;

FIG. 5A schematically illustrates a state in which one of a plurality of spraying portions of is gripped by a transfer unit;

FIG. 5B schematically illustrates a state in which a transfer unit is being transferred while gripping a spraying portion;

FIG. 5C schematically illustrates a state in which a transfer unit is transferring a spraying portion to a cleaning unit;

FIG. 6 schematically illustrates a state in which a transfer unit is separated after transferring a spraying portion to a cleaning unit;

FIG. 7 is a flowchart illustrating a method of cleaning a treatment liquid coating apparatus according to an example embodiment of the present disclosure;

FIG. 8 is a schematic cross-sectional view of one operation of a method of cleaning the treatment liquid coating apparatus of FIG. 7;

FIG. 9A is a schematic cross-sectional view of another operation of a method of cleaning the treatment liquid coating apparatus of FIG. 7;

FIG. 9B is a schematic cross-sectional view of another operation of a method of cleaning the treatment liquid coating apparatus of FIG. 7;

FIG. 9C is a schematic cross-sectional view of another operation of a method of cleaning the treatment liquid coating apparatus of FIG. 7;

FIG. 9D is a schematic cross-sectional view of another operation of a method of cleaning the treatment liquid coating apparatus of FIG. 7;

FIG. 10A is a schematic cross-sectional view of another operation of a method of cleaning the treatment liquid coating apparatus of FIG. 7;

FIG. 10B is a schematic cross-sectional view of another operation of a method of cleaning the treatment liquid coating apparatus of FIG. 7;

FIG. 10C is a schematic cross-sectional view of another operation of a method of cleaning the treatment liquid coating apparatus of FIG. 7;

FIG. 11A is a schematic cross-sectional view of another operation of a method of cleaning the treatment liquid coating apparatus of FIG. 7; and

FIG. 11B is a schematic cross-sectional view of another operation of a method of cleaning the treatment liquid coating apparatus of FIG. 7.

### DETAILED DESCRIPTION

Hereinafter, preferred example embodiments will be described in detail, such that the disclosure could be easily carried out. In describing example embodiments of the present disclosure, when it is determined that a detailed description of a known technology related to the present disclosure may unnecessarily obscure the gist of the present disclosure, a detailed description thereof will be omitted. In addition, the same reference numerals are used throughout the drawings with respect to components having similar functions and actions. In addition, in the present specification, terms such as “upper,” “upper portion,” “upper surface,” “lower,” “lower portion,” “lower surface,” and “side surface” are based on the drawings, may vary depending on a direction in which an element or component is actually arranged.

In addition, it will be understood that “comprises,” “comprising,” “includes,” and “including” specify the presence of stated features, integers, operations, operations, elements, components or a combination thereof, but do not preclude the presence or addition of one or more other features, integers, operations, operations, elements, components, and/or groups thereof.

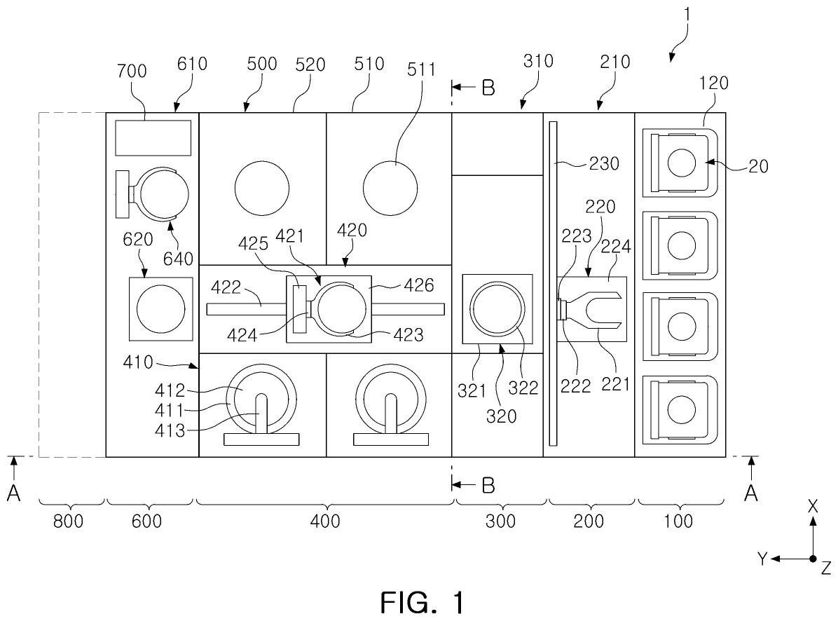

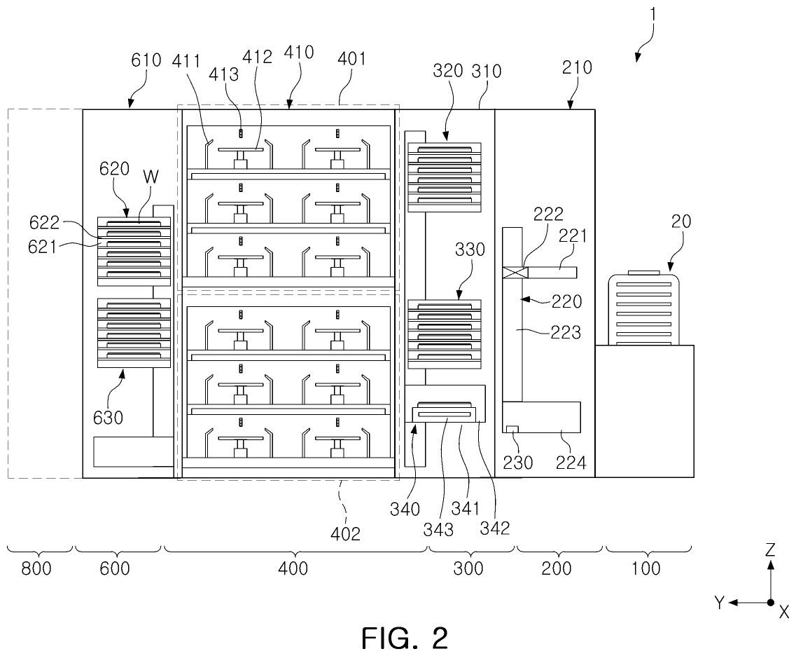

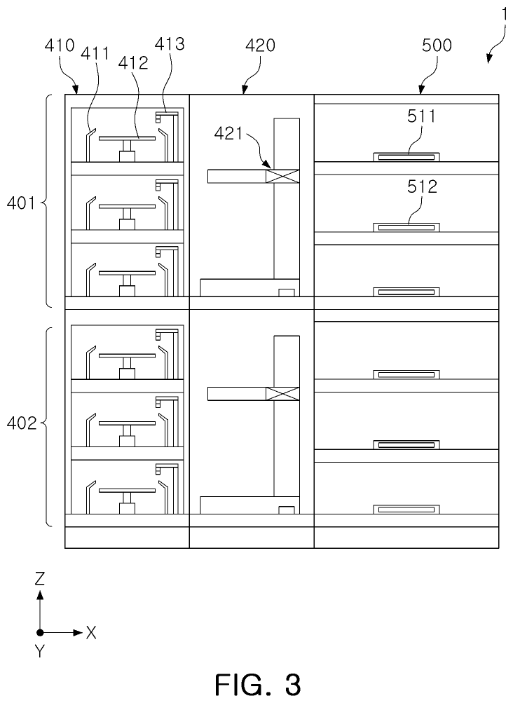

FIG. 1 is a top view of a substrate treatment apparatus according to an example embodiment of the present disclosure. FIG. 2 is a view of the substrate treatment apparatus of FIG. 1 in a direction of A-A. FIG. 3 is a view of the substrate treatment apparatus of FIG. 1 in a direction of B-B.

Referring to FIGS. 1 to 3, a substrate treatment apparatus 1 may include a load port 100, an index module 200, a buffer module 300, a coating and development module 400, and a purge module 700. The load port 100, the index module 200, the buffer module 300, the coating and development module 400, and an interface module 600 may be sequentially disposed in a line in one direction. The purge module 700 may be provided in the interface module 600. Alternatively, the purge module 700 may be provided in various positions such as a position to which an exposure device 800 at a rear end of the interface module 600 is connected, a side portion of the interface module 600, or the like. Hereinafter, a direction in which the load port 100, the index module 200, the buffer module 300, the coating and development module 400, and the interface module 600 are disposed may be referred to as a first direction Y, a direction, perpendicular to the first direction Y when viewed from above, may be referred to as a second direction X, and a direction, perpendicular to each of the first direction Y and the second direction X, may be referred to as a third direction Z.

A substrate W may be moved in a state of being accommodated in a cassette 20. The cassette 20 may be sealed externally. For example, a front open integrated pod (FOUP), having a door in front thereof, may be used as the cassette 20.

Hereinafter, the load port 100, the index module 200, the buffer module 300, the coating and development module 400, the interface module 600, and the purge module 700 will be described in detail.

The load port 100 may have a mounting table 120 on which the cassette 20 in which the substrate W is accommodated is disposed. A plurality of mounting tables 120 may be provided, and the mounting tables 120 may be disposed in a line in the second direction X. FIG. 1 illustrates an example in which four mounting tables 120 are provided, but the number of mounting tables 120 may be changed.

The index module 200 may transfer the substrate W between the cassette 20 disposed on the mounting table 120 of the load port 100 and the buffer module 300. The index module 200 may include a frame 210, an index robot 220, and a guide rail 230.

The frame 210 may have a rectangular parallelepiped shape having an empty space therein, and may be disposed between the load port 100 and the buffer module 300. The frame 210 of the index module 200 may have a height, lower than that of a frame 310 of the buffer module 300.

The index robot 220 and the guide rail 230 may be disposed in the frame 210. The index robot 220 may be provided such that the hand 221, directly handling the substrate W, is movable and rotatable in the first direction Y, the second direction X, and the third direction Z. The index robot 220 may include a hand 221, an arm 222, a support 223, and a pedestal 224. The hand 221 may be fixedly installed on the arm 222. The arm 222 may have a stretchable structure and a rotatable structure. The support 425 may be disposed such that a length direction thereof is the same as the third direction Z. The arm 222 may be coupled to the support 223 to be movable along the support 223. The support 223 may be fixedly coupled to the pedestal 224. The guide rail 230 may be disposed such that a length direction thereof is the same as the second direction X. The pedestal 224 may be coupled to the guide rail 230 to be linearly movable along the guide rail 230. In addition, although not illustrated, the frame 210 may further have a door opener for opening and closing a door of the cassette 20.

The buffer module 300 may include the frame 310, a first buffer 320, a second buffer 330, and a cooling chamber 340. The frame 310 may have a rectangular parallelepiped shape having an empty space therein, and may be disposed between the index module 200 and the coating and development module 400. The first buffer 320, the second buffer 330, and the cooling chamber 340 may be positioned in the frame 310. The cooling chamber 340, the second buffer 330, and the first buffer 320 may be sequentially disposed from the bottom in the third direction Z. The first buffer 320 may be positioned to have a height corresponding to that of a coating module 401 of the coating and development module 400, and the second buffer 330 and the cooling chamber 340 may be positioned to have a height corresponding to that of a development module 402 of the coating and development module 400.

Each of the first buffer 320 and the second buffer 330 may temporarily store a plurality of substrates W. The first buffer 320 may have a housing 321 and a plurality of supports 322. In the first buffer 320, the supports 322 may be disposed in the housing 321 and may be spaced apart from each other in the third direction Z. The second buffer 330 may have a housing 331 and a plurality of supports 332. In the second buffer 330, the supports 332 may be disposed in the housing 331 and may be spaced apart from each other in the third direction Z. A single substrate W may be positioned in each support 322 of the first buffer 320 and each support 332 of the second buffer 330. The housing 331 may have an opening in a direction in which the index robot 220 is provided, such that the index robot 220 may carry the substrate W in or out of the support 332 in the housing 331.

The first 320 have buffer a structure may substantially similar to that of the second buffer 330. However, the housing 321 of the first buffer 320 may have openings in a direction in which a first buffer robot 360 is provided and in a direction in which a coating portion robot 421 positioned in the coating module 401 is provided. The number of supports 322 provided in the first buffer 320 may be the same or different from the number of supports 332 provided in the second buffer 330. According to an example, the number of supports 332 provided in the second buffer 330 may be greater than the number of supports 322 provided in the first buffer 320.

The cooling chamber 340 may cool the substrate W. The cooling chamber 340 may include a housing 341 and a cooling plate 342. The cooling plate 342 may have an upper surface on which the substrate W is disposed, and a cooling means 343 for cooling the substrate W. Various methods, such as cooling using coolant or cooling using a thermoelectric element, may be used as the cooling means 343. In addition, the cooling chamber 340 may include a lift pin assembly for positioning the substrate W on the cooling plate 342. The housing 341 may have openings in a direction in which the index robot 220 is provided and in a direction in which a development portion robot, provided in the development module 402, is provided, such that the index robot 220 and the development portion robot may carry the substrate W into or out of the cooling plate 342. In addition, doors for opening and closing the above-described openings may be provided in the cooling chamber 340.

In the above-described example embodiments, the buffer module 300 has been described to include the cooling chamber 340, but the present disclosure is not limited thereto, and the cooling chamber 340 may be omitted, as necessary.

The coating module 401 may include a process of coating a photosensitive liquid such as a photoresist on the substrate W, and a heat treatment process, such as heating and cooling of the substrate W, before and after a resist coating process. The coating module 401 may have a coating chamber 410, a heat treatment chamber portion 500, and a conveyance chamber 420. The coating chamber 410, the conveyance chamber 420, and the heat treatment chamber portion 500 may be sequentially disposed in the second direction X. That is, with respect to the conveyance chamber 420, the coating chamber 410 may be provided on one side of the conveyance chamber 420, and the heat treatment chamber portion 500 may be provided on the other side of the conveyance chamber 420.

A plurality of coating chambers 410 may be provided in the third direction Z. In addition, as illustrated in FIG. 1, a plurality of coating chambers 410 may be provided, or a single coating member 410 may be provided in the first direction Y.

The heat treatment chamber portion 500 may include a baking chamber 510 and a cooling chamber 520, and a plurality of baking chambers 510 and a plurality of cooling chambers 520 may be provided in the third direction Z. The conveyance chamber 420 may be positioned to be parallel to the first buffer 320 of the first buffer module 300 in the first direction Y. The coating portion robot 421 and the guide rail 422 may be positioned in the conveyance chamber 420. The conveyance chamber 420 may have a substantially rectangular shape. The coating portion robot 421 may transfer the substrate W, between the baking chamber 510, the cooling chamber 520, the coating chamber 410, and the first buffer 320 of the first buffer module 300.

The guide rail 422 may be disposed such that a length direction thereof is parallel to the first direction Y. The guide rail 422 may guide the coating portion robot 421 to linearly move in the first direction Y. The coating portion robot 421 may have a hand 423, an arm 424, a support 425, and a pedestal 426. The hand 423 may be fixedly installed on the arm 424. The arm 424 may have a stretchable structure, such that the hand 423 may move in a horizontal direction. The support 425 may be disposed such that a length direction thereof is the same as the third direction Z. The arm 424 may be coupled to the support 425 to be linearly movable in the third direction Z along the support 425. The support 425 may be fixedly coupled to the pedestal 426, and the pedestal 426 may be coupled to the guide rail 422 to be movable along the guide rail 422.

All of the coating chambers 410 may have the same structure. However, types of treatment liquids used in the coating chambers 410 may be different from each other. As a treatment liquid PR for forming a photoresist film or an antireflection film may be used.

A treatment container 411 and a support portion 412 may be disposed in the coating chamber 410. In addition, a treatment liquid coating apparatus 900 may be disposed in the coating chamber 410. The treatment liquid coating apparatus 900 may be an apparatus for coating the treatment liquid PR on the substrate W, and may include a spraying portion 920 and a suck-back portion 940, and a detailed description thereof will be provided below.

The treatment container 411 of the coating chamber 410 may have a shape having an open upper portion. The support portion 412 may be disposed in the treatment container 411, and may support the substrate W. The support portion 412 may be provided to be rotatable. In addition, the coating chamber 410 may further selectively include a nozzle (not illustrated) for supplying a cleaning liquid TH, such as deionized water (DIW), to clean a surface of the substrate W on which the treatment liquid PR is coated, and a back rinse nozzle (not illustrated) for cleaning a lower surface of the substrate W.

At least one treatment liquid coating apparatus 900 may be provided. For example, one treatment liquid coating apparatus 900 may be disposed in the coating chamber 410 in the first direction Y, but the present disclosure is not limited thereto, and two or more treatment liquid coating apparatuses 900 may be disposed in a single coating chamber 410. In this case, the treatment liquid coating apparatuses 900 may all have the same structure. However, types of treatment liquids PR used in the treatment liquid coating apparatuses 900 may be the same or different from each other.

In the baking chamber 510, when the substrate W is mounted by the coating portion robot 421, the substrate W may be heat-treated. In the baking chamber 510, a pre-baking process of removing organic matter or moisture from the surface of the substrate W by heating the substrate W to a predetermined temperature may be performed before the treatment liquid PR is coated, or a soft baking process may be performed after the treatment liquid PR coated on a wafer W, and a cooling process of cooling the substrate W may be performed after each heating process.

A heating plate 511 and a heating means 511a may be provided in the baking chamber 510.

The heating means 511a may heat the substrate W disposed in the baking chamber 510. In this case, the substrate W may be heated in a state in which the baking chamber 510 is sealed, and the heating means 511a may heat the entire region of the substrate W to a uniform temperature. Such a heat treatment process may stabilize a liquid film by blowing organic matter on the liquid film formed by coating the treatment liquid PR to the substrate W. Various methods, such as a heating method using a heating wire provided on the inside or outside of the heating plate 511 or a heating method using a heater disposed on the inside or outside of the baking chamber 510, may be used as the heating means 511a.

In addition, the baking chamber 510 may further include a cooling plate 512. The cooling plate may receive coolant from a cooling unit 910 to be described below to cool the substrate W, thereby preventing the substrate W from being heated to an excessively high temperature by the heat treatment process. After the heat treatment process is completed, the substrate W may be transferred to the cooling chamber 520.

The cooling chamber 520 may perform a cooling process of cooling the substrate W before the treatment liquid PR is coated. The cooling chamber 520 may include a cooling plate. The cooling plate may include a cooling means in which various methods, such as cooling using a coolant or cooling using a thermoelectric element, are used to cool the substrate W.

The interface module 600 may connect the coating and development module 400 to an external exposure device 800. The interface module 600 may include an interface frame 610, a first interface buffer 620, a second interface buffer 630, and a conveyance robot 640, and the conveyance robot 640 may convey, to the exposure device 800, the substrate conveyed to the first and second interface buffers 620 and 630 after the coating and development module 400 is terminated. The first and second interface buffers 620 may include a housing 621 and a support 622, and the conveyance robot 640 and the coating portion robot 421 may carry the substrate W into/out of the support 622.

The treatment liquid coating apparatus 900 may be an apparatus for coating various types of treatment liquids PR used in a treatment process of the substrate W on the substrate W. In this case, various types of treatment liquids PR including a photoresist liquid may be coated. However, for ease of description, a case in which the treatment liquid PR is a photoresist liquid will be mainly described.

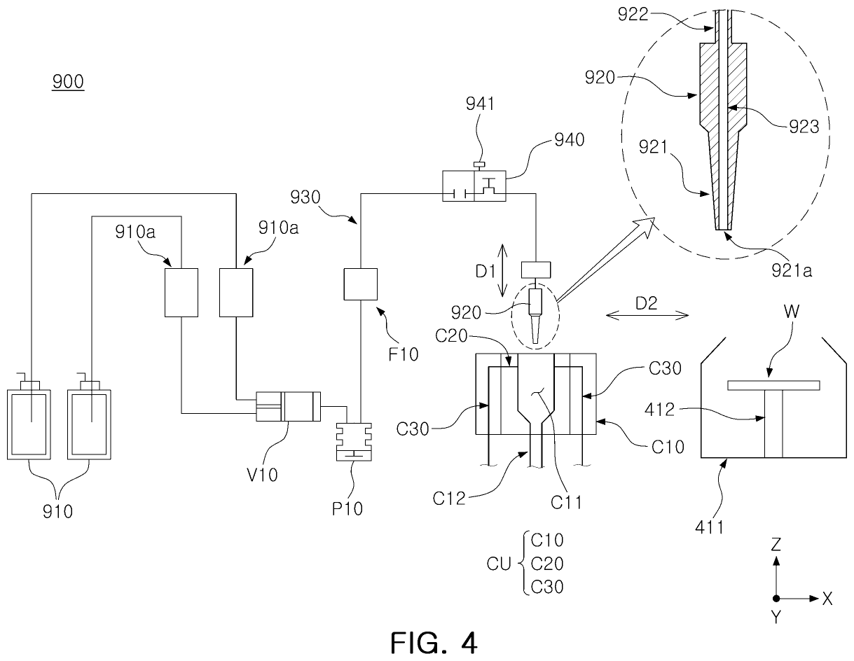

FIG. 4 schematically illustrates a treatment liquid coating apparatus according to an example embodiment of the present disclosure.

Referring to FIG. 4, the treatment liquid application apparatus 900 according to an example embodiment of the present disclosure may include a treatment liquid supply source 910, a spraying portion 920, a supply line 930, a suck-back portion 940, and a cleaning unit CU. In addition, the treatment liquid application apparatus 900 may further include a buffer tank 910a in which the treatment liquid PR is temporarily stored, a main valve V10 opening and closing the supply line 930, a supply pump P10 supplying the treatment liquid PR to the spraying portion 920 at a constant pressure, and a filter F10 of the treatment liquid PR.

The treatment liquid PR may be stored in the treatment liquid supply source 910. The treatment liquid PR may be, for example, a photoresist liquid, but the present disclosure is not limited thereto. The treatment liquid supply source 910 may be connected to the spraying portion 920 through the supply line 930. The supply line 930 may be a path through which the treatment liquid PR stored in the treatment liquid supply source 910 moves to the spraying portion 920.

The spraying portion 920 may spray the treatment liquid PR onto the substrate W. The spraying portion 920 may be a spray nozzle capable of spraying the treatment liquid PR. In this case, the spraying portion 920 may include a nozzle tip 921, an extension portion 922, and a discharge flow path 923.

The discharge flow path 923 may extend through the inside of the spraying portion 920. For example, when the spray port 920 is coupled to a transfer unit S to be described below, an upper end of the discharge flow path 923 may be connected to the supply line 930 through the transfer unit S. In addition, a lower end of the discharge flow path 923 may extend to the inside of the nozzle tip 921. In this case, the discharge flow path 923 may communicate with the outside of the spraying portion 920 through an outlet 921a of the nozzle tip 921.

The spraying portion 920 may be connected to the treatment liquid supply source 910 by the supply line 930. The buffer tank 910a, the main valve V10, the supply pump P10, a filter F10 of the treatment liquid PR, and the suck-back portion 940 may be sequentially disposed between the treatment liquid supply source 910 and the spraying portion 920, and may be connected to each other through the supply line 930.

The treatment liquid PR, stored in the treatment liquid supply source 910, may be transferred along the supply line 930 and temporarily stored in the buffer tank 910a. Thereafter, the treatment liquid PR, transferred along the supply line 930 according to an operation of opening and closing the main valve V10, may pass through the filter F10 of the treatment liquid PR and the suck-back portion 940, and may then be supplied to the spraying portion 920 by pressure provided by the supply pump P10. In this case, the treatment liquid PR may pass through the filter F10, and foreign substances or the like may be removed. The treatment liquid PR supplied through such a process may be coated on the substrate W through the spraying portion 920.

After the spraying portion 920 sprays a preset amount of the treatment liquid PR, a predetermined amount of the treatment liquid PR may remain in the discharge flow path 923. In this case, the suck-back portion 940 may suck-back the treatment liquid PR remaining in the discharge flow path 923 of the spraying portion 920.

The suck-back portion 940 may be configured as, for example, a suck-back valve including a diaphragm (not illustrated). Due to the action of the diaphragm of the suck-back portion 940, the treatment liquid PR may be sucked inwardly (backwardly) from the outlet 921a of the nozzle tip 921 of the spraying portion 920 and moved to the inside of the discharge flow path 923, thereby preventing the treatment liquid PR remaining in the process liquid discharge flow path 923 of the spraying portion 920 from being cured at the nozzle tip 921 and a surrounding portion thereof or from being dropped on the substrate W in a subsequent substrate treatment process.

The suck-back portion 940 may include a suck-back adjustment portion 941 operating the suck-back valve. For example, the compression and recovery of the diaphragm of the suck-back portion 940 may be adjusted by the suck-back adjustment portion 941, thereby increasing or reducing a suck-back amount of the treatment liquid PR.

The cleaning unit CU may clean the spraying portion 920 before/after a treatment process of coating the treatment liquid PR on the substrate W. As illustrated in FIG. 4, the cleaning unit CU may be disposed to be spaced apart from the treatment container 411. In this case, the cleaning unit CU may include a cleaning container C10, a cleaning liquid supply portion C20, and a cleaning liquid supply flow path C30.

The cleaning container C10, a body of the cleaning unit CU, may have an open upper portion. The cleaning container C10 may have an accommodation space C11, in which the nozzle tip 921 is accommodated, therein. The accommodation space C11 may have a shape that is concave downwardly from an open upper end of the cleaning container C10.

A discharge portion C12 may be provided at a lower end of the cleaning container C10. For example, the discharge portion C12 may be formed as a pipe or a tube. In this case, one end of the discharge portion C12 may be connected to the accommodation space C11, and the other end of the discharge portion C12 may communicate with the outside. In this case, the treatment liquid PR, discharged from the nozzle tip 921, and the cleaning liquid TH, supplied and sprayed by the cleaning liquid supply portion C20, may be accommodated in the accommodation space C11. The treatment liquid PR and the cleaning liquid TH, accommodated in the accommodation space C11, may be externally discharged through the discharge portion C12.

The discharge portion C12 may have a diameter, less than that of the cleaning container C10. In this case, the diameter of the discharge portion C12 may be changed based on viscosity of the treatment liquid PR used when the substrate W is treated. For example, when the treatment liquid PR having high viscosity is used, the discharge portion C12 may be formed to have a diameter, greater than that of the discharge portion C12 when the treatment liquid PR having relatively low viscosity is cleaned and discharged.

The cleaning liquid supply portion C20 may be connected to a supply device (not illustrated) for the cleaning liquid TH through the cleaning liquid supply flow path C30.

In an example embodiment, the cleaning liquid supply portion C20 may be in the form of a pipe or tube formed to pass through a sidewall of the cleaning container C10. In this case, the cleaning liquid supply portion C20 may extend in a width direction X of the sidewall of the cleaning container C10 to communicate with the accommodation space C11. In this case, the cleaning liquid supply portion C20 may be disposed at a lower end of the cleaning container C10. More specifically, when the spraying portion 920 is lowered to a sucking position to be described below, the cleaning liquid supply portion C20 may be disposed below the nozzle tip 921. In addition, the cleaning liquid supply portion C20 may be disposed above the discharge portion C12 of the cleaning container C10. Accordingly, the cleaning liquid supply portion C20 may be disposed between the nozzle tip 921 and the discharge portion C12 in a vertical direction Z.

In addition, the cleaning liquid supply flow path C30 may be disposed on the inside of the sidewall of the cleaning container C10. In this case, the cleaning liquid supply flow path C30 may extend in a longitudinal direction Z of the sidewall of the cleaning container C10. The cleaning liquid supply flow path C30 may be connected to a cleaning liquid supply device (not illustrated) disposed on the outside of the cleaning container C10.

The cleaning liquid supply portion C20 may receive the cleaning liquid TH from the supply device for the cleaning liquid TH through the cleaning liquid supply flow path C30. In addition, the cleaning liquid supply portion C20 may spray the supplied cleaning liquid TH into the accommodation space C11. The cleaning liquid TH may be, for example, a thinner.

The above-described cleaning liquid supply portion C20 may be provided as a plurality of cleaning liquid supply portions C20. In this case, the plurality of cleaning liquid supply portions C20 may be disposed on the sidewall of the cleaning container C10 to be spaced apart from each other along a circumferential direction of the cleaning container C10. By such an arrangement, when the cleaning liquid TH is first supplied into the accommodation space C11, the cleaning liquid TH may be sprayed into the accommodation space C11 in a side direction (for example, a direction, parallel to an X-Y plane). Subsequently, the cleaning liquid TH may be lowered toward the discharge portion C12 in the accommodation space C11. In the process in which the cleaning liquid TH is lowered, the cleaning liquid TH may form a predetermined swirling flow, thereby improving a cleaning effect on an inner wall surface of a lower end of the accommodation space C11.

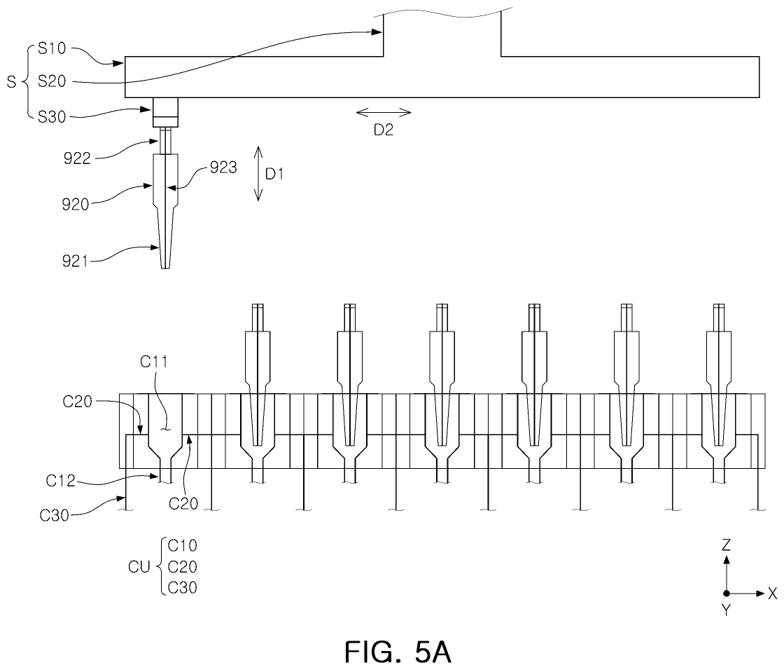

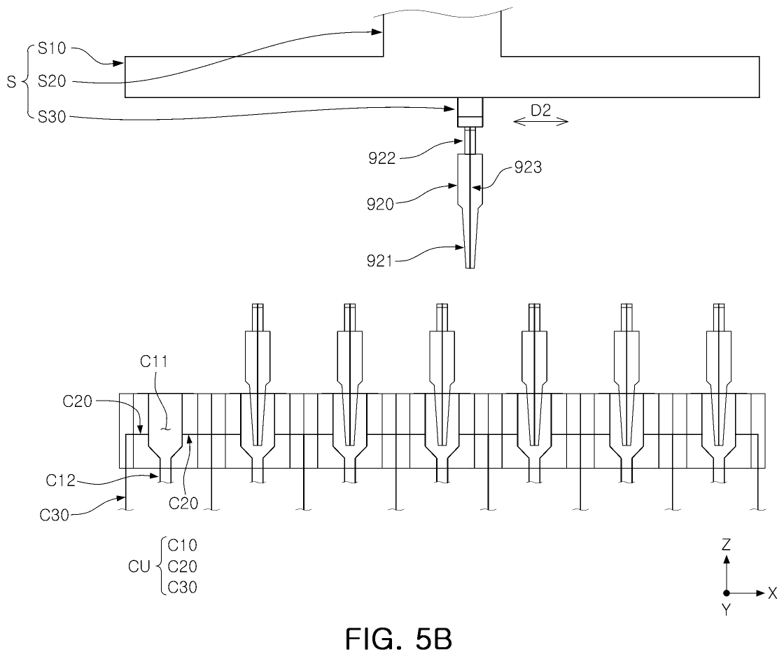

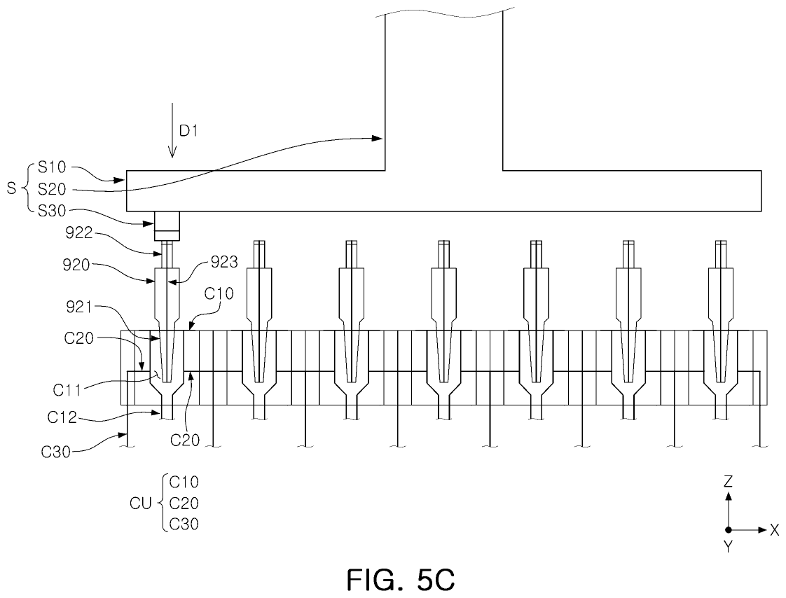

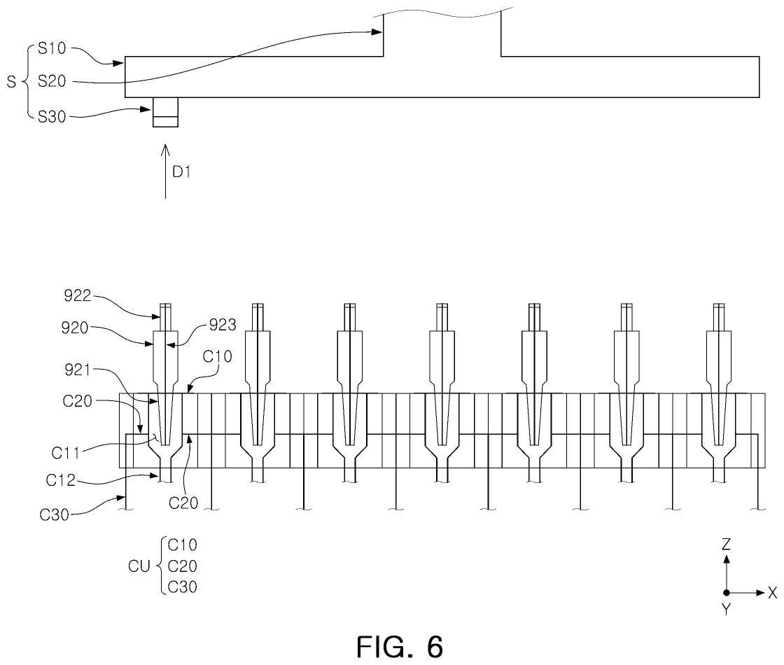

FIG. 5A schematically illustrates a state in which one of a plurality of spraying portions of is gripped by a transfer unit. FIG. 5B schematically illustrates a state in which a transfer unit is being transferred while gripping a spraying portion. FIG. 5C schematically illustrates a state in which a transfer unit is transferring a spraying portion to a cleaning unit. FIG. 6 schematically illustrates a state in which a transfer unit is separated after transferring a spraying portion to a cleaning unit.

Referring to FIGS. 5A, 5B, 5C, and 6, the spraying portion 920 may be disposed in the cleaning unit CU. In this case, at least a portion of the spraying portion 920 may be accommodated in the accommodation space C11 of the cleaning container C10. In this case, the above-described portion of the spraying portion 920 may be the nozzle tip 921.

The spraying portion 920 may be provided as at least one spraying portion 920. In an example embodiment, the spraying portion 920 may be provided as a plurality of spraying portions 920. In this case, the number of cleaning units CU may be equal to the number of spraying portions 920. In this case, the spraying portions 920 and the cleaning units CU may be disposed to respectively oppose each other in the vertical direction Z. That is, the plurality of spraying portions 920 may be disposed in a state of respectively being inserted into the accommodation space C11 of the cleaning unit CU opposing the nozzle tip 921. In this state, the spraying portion 920 may be supported by a support device (not illustrated).

An example embodiment in which seven spraying portions 920 and seven cleaning units CU are provided is illustrated in the drawings, but the present disclosure is not limited thereto.

The transfer unit S may be selectively coupled to the spraying portion 920 to change a position of the spraying portion 920. More specifically, the transfer unit S may transfer the spraying portion 920 between the cleaning unit CU and a target position. Here, the target position may be a place in which a treatment process for the substrate W is performed using the spraying portion 920, and may be, for example, an upper portion of the treatment container 411.

The transfer unit S may include a guide portion S10, a raising/lowering portion S20, and a coupling portion S30. The transfer unit S may be installed on a support (not illustrated). In addition, the transfer unit S may include a driving portion (not illustrated) providing driving force required to drive the raising/lowering portion S20 and the coupling portion S30. The driving portion may operate using various methods such as a hydraulic cylinder method, a method using a linear motor, or the like.

The guide portion S10 may extend in one direction (for example, an X-axis direction in the drawing). In an example embodiment, the raising/lowering portion S20 may be connected to the guide portion S10, such that the raising/lowering portion S20 may be raised or lowered in the vertical direction Z (or a raising/lowering direction D1). Although not illustrated in the drawings, in another example embodiment, the raising/lowering portion S20 may be disposed between the guide portion S10 and the coupling portion S30. In this case, when the coupling portion S30 is raised or lowered, only the coupling portion S30 may be raised or lowered by the raising/lowering portion S20.

The coupling portion S30, a portion coupled to the spraying portion 920, may be movably connected to the guide portion S10. Accordingly, the coupling portion S30 may reciprocate in a longitudinal direction X (or a horizontal direction D2) of the guide portion S10. The coupling portion S30 may be coupled to or separated from the spraying portion 920 using various methods. For example, the coupling portion S30 may include a robot hand. In this case, the coupling portion S30 may selectively grip the spraying portion 920 using the robot hand.

As illustrated in FIG. 5A, the coupling portion S30 may be raised in the direction D1 by the raising/lowering portion S20 in a state of gripping the spraying portion 920. When the spraying portion 920 is gripped (coupled) by the coupling portion S30, the discharge flow path 923 may be connected to the supply line 930 through an internal flow path (not illustrated) of the transfer unit S.

After being raised, as illustrated in FIG. 5B, the coupling portion S30 may move in the horizontal direction D2 along the guide portion S10. Accordingly, the spraying portion 920 may be transferred to the target position. Although not illustrated in the drawings, a rotatable arm (not illustrated) may be installed between the coupling portion S30 and the guide portion S10. In this case, the coupling portion S30 and the spraying portion 920 may move to the target position due to linear movement in the horizontal direction D2 and rotational motion of the arm. When the target position is reached, the treatment liquid PR may be supplied to the spraying portion 920 through the supply line 930 and the discharge flow path 923 connected thereto. A substrate treatment process may be performed by supplying the treatment liquid PR to the substrate W using the spraying portion 920.

When the substrate treatment process using the spraying portion 920 coupled to the coupling portion S30 is completed, the coupling portion S30 may be returned to an original position thereof. That is, the coupling portion S30 may move to an upper portion of the cleaning unit CU in which the spraying portion 920 is disposed in the horizontal direction D2. Subsequently, as illustrated in FIG. 5C, the coupling portion S30 may be lowered in the direction D1 by the raising/lowering portion S20, the nozzle tip 921 of the spraying portion 920 coupled thereto may be accommodated in the accommodation space C11 again.

Thereafter, when the spraying portion 920 is supported by the support device (not illustrated) described above, the coupling portion S30 may release a state of gripping the spraying portion 920. When the coupling portion S30 is separated from the spraying portion 920, as illustrated in FIG. 6, the raising/lowering portion S20 may be raised again in the direction D1.

A cleaning operation may be performed on the spraying portion 920 returned to the cleaning unit CU after the substrate treatment process is performed. In addition, the transfer unit S may grip one spraying portion 920, among the remaining spraying portions 920, and may transfer the spraying portion 920 to the target position, so that the next substrate treatment process may be performed.

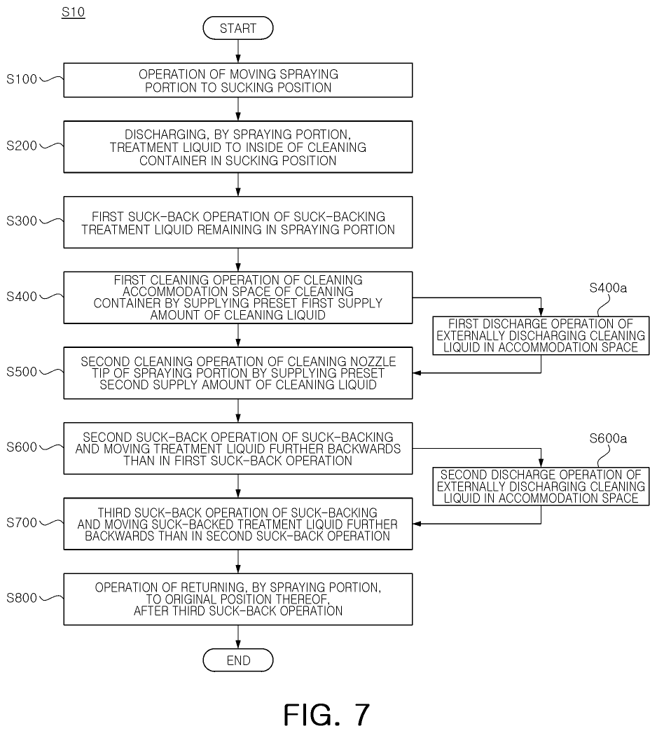

FIG. 7 is a flowchart illustrating a method of cleaning a treatment liquid coating apparatus according to an example embodiment of the present disclosure.

Referring to FIG. 7, a method of cleaning the treatment liquid coating apparatus 900 according to example embodiments of the present disclosure (hereinafter, a treatment liquid coating apparatus cleaning method) (S10) may include an operation (S100) of moving a spraying portion 920 to a sucking position, an operation (S200) of discharging, by the spraying portion 920, a treatment liquid PR to the inside of a cleaning unit CU in the sucking position, a first suck-back operation (S300) of suck-backing the treatment liquid PR remaining in the spraying portion 920, a first cleaning operation (S400) of cleaning an accommodation space C11 of the cleaning container C10 by supplying a preset first supply amount of cleaning liquid TH, a second cleaning operation (S500) of cleaning a nozzle tip of the spraying portion by supplying a preset second supply amount of cleaning liquid, a second suck-back operation (S600) of suck-backing and moving the treatment liquid PR further backwards than in the first suck-back operation (S300), and a third suck-back operation (S700) of suck-backing and moving the suck-backed treatment liquid PR further backwards than in the second suck-back operation (S600).

In addition, the treatment liquid coating apparatus cleaning method (S10) may further include a first discharge operation (S400a) of externally discharging the cleaning liquid TH in the accommodation space C11, between the first cleaning operation and the second cleaning operation, and a second discharge operation (S600a) of externally discharging the cleaning liquid TH in the accommodation space C11, before the third suck-back operation (S700). Respective operations of the treatment liquid coating apparatus cleaning method (S10) will be described in detail below.

For ease of description, one spraying portion 920 and one cleaning unit CU will be mainly described. However, even when there are a plurality of spraying portions 920 and a plurality of cleaning units CU, the same or similar method may be performed.

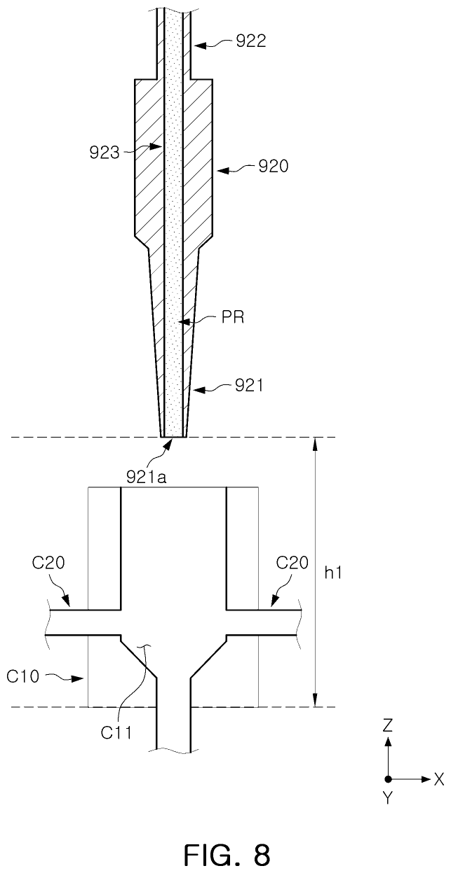

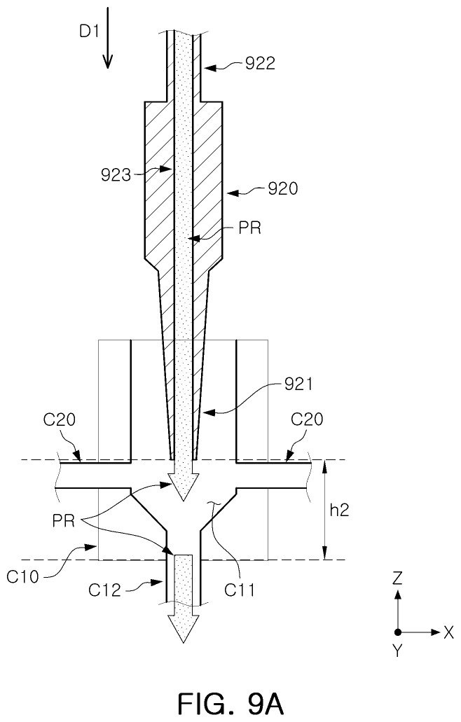

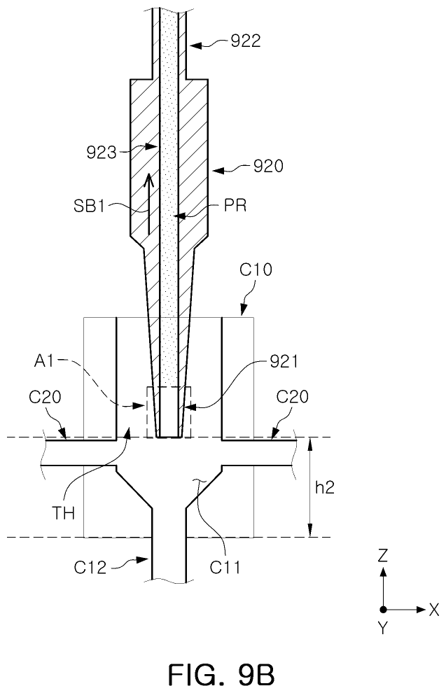

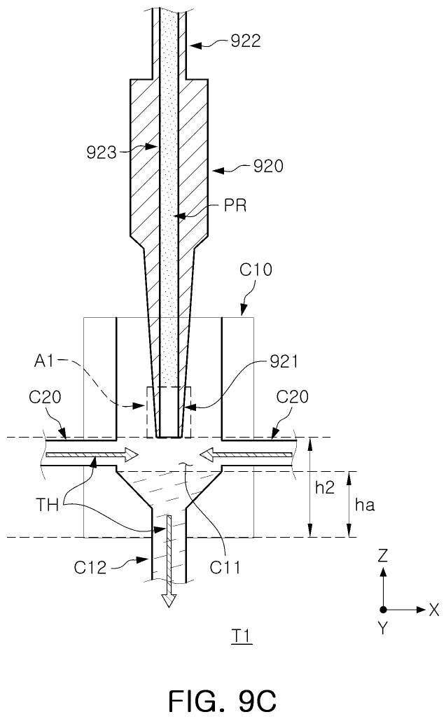

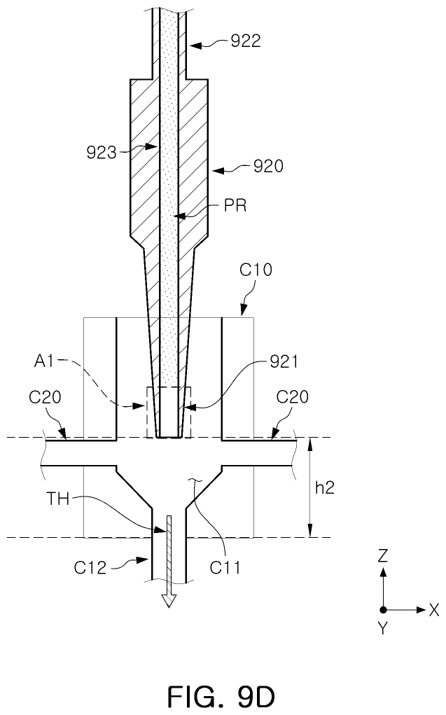

FIG. 8 is a schematic cross-sectional view of one operation of a method of cleaning the treatment liquid coating apparatus of FIG. 7. FIG. 9A is a schematic cross-sectional view of another operation of a method of cleaning the treatment liquid coating apparatus of FIG. 7. FIG. 9B is a schematic cross-sectional view of another operation of a method of cleaning the treatment liquid coating apparatus of FIG. 7. FIG. 9C is a schematic cross-sectional view of another operation of a method of cleaning the treatment liquid coating apparatus of FIG. 7. FIG. 9D is a schematic cross-sectional view of another operation of a method of cleaning the treatment liquid coating apparatus of FIG. 7.

Referring to FIG. 8, first, the spraying portion 920 may be positioned on an upper side of the cleaning unit CU (hereinafter, referred to as an “initial position”). In this case, the spraying portion 920 may be transferred to the initial position by a transfer unit S. In the initial position, a nozzle tip 921 of the spraying portion 920 may oppose an open upper end of the cleaning container C10 in a vertical direction Z. In this case, an end of the nozzle tip 921 may be spaced apart from a lower end of the cleaning container C10 by a first height h1. In addition, in an initial state, the treatment liquid PR may remain in a discharge flow path 923. The remaining treatment liquid PR may be, for example, a portion of the treatment liquid PR, used in a previous substrate treatment process, remaining in the discharge flow path 923.

Referring to FIG. 9A, the spraying portion 920 may be lowered in the direction D1 by the transfer unit S (S100). In the spraying portion 920, at least a portion (for example, a lower end) of the nozzle tip 921 may move to the inside of the cleaning container C10 (that is, the accommodation space C11) (S100). A position of the spraying portion 920 lowered in such a manner will be defined as a “sucking position.” In the sucking position, an end of the nozzle tip 921 may be spaced apart from a lower end of the cleaning container C10 by a second height h2. In this case, the second height h2 may be lower than the first height h1.

Referring again to FIG. 9A, in the sucking position in the operation (S100), the treatment liquid PR may be discharged from the spraying portion 920 (S200). The treatment liquid PR may be, for example, a photoresist liquid. More specifically, the treatment liquid PR remaining in the discharge flow path 923 may be discharged into the accommodation space C11 through an outlet 921a of the nozzle tip 921. The discharged treatment liquid PR may pass through the accommodation space C11 and be externally discharged through a discharge portion C12 at the lower end of the cleaning container C10.

Referring to FIG. 9B, a “first suck-back operation” of suck-backing the treatment liquid PR remaining in the spraying portion 920 (hereinafter, referred to as first suck-back SB1) may be performed (S300). In this case, the first suck-back SB1 may be performed in the sucking position (or a state in which the nozzle tip 921 is disposed to have the second height h2).

More specifically, after a portion of the treatment liquid PR is discharged in the operation (S200), the treatment liquid PR may remain at the outlet 921a of the nozzle tip 921 and in the discharge flow path 923 adjacent thereto. The remaining treatment liquid PR may be sucked backwardly (for example, in an upward direction in the drawings) (+Z), as illustrated in FIG. 9B, by a sucking operation of a suck-back portion 940. That is, the treatment liquid PR may be sucked and moved backward of the nozzle tip 921 in the discharge flow path 923. Accordingly, in the discharge flow path 923 adjacent to the outlet 921a of the nozzle tip 921, a “first air layer A1,” filled only with air and with almost no treatment liquid PR, may be formed.

Referring to FIG. 9C, the first cleaning operation (S400) of cleaning the accommodation space C11 of the cleaning container C10 may be performed. To this end, the cleaning liquid TH may be supplied to the accommodation space C11. The cleaning liquid TH may be, for example, a thinner. In this case, the first cleaning operation (S400) may be performed in the sucking position. That is, the operation (S400) may be performed in a position, the same as that in operations S100 to S300, without further lowering or raising the spraying portion 920.

More specifically, the cleaning liquid TH may pass through a cleaning liquid supply flow path C30 and be sprayed into the accommodation space C11 through a cleaning liquid supply portion C20, from a cleaning liquid supply device (not illustrated). In the operation (S400), a “preset first supply amount” of cleaning liquid TH may be supplied and sprayed. Accordingly, the cleaning liquid TH may be filled in the accommodation space C11 to reach a first liquid level ha. As described, a state in which the cleaning liquid TH is filled in the accommodation space C11 at the first liquid level ha will be defined as a “first filling state T1.” In this case, the preset first supply amount may be changed according to an internal volume of the accommodation space C11.

In the first filling state T1, the nozzle tip 921 of the spraying portion 920 may not be in contact with the cleaning liquid TH filled in the accommodation space C11. That is, in the first filling state T1, the end of the nozzle tip 921 may be spaced apart from a liquid surface of the cleaning liquid TH, the first liquid level ha. Accordingly, while the first cleaning operation (S400) is performed, foreign substances such as the treatment liquid PR at the nozzle tip 921 may not be introduced into the cleaning liquid TH filled in the accommodation space C11. That is, in the first cleaning operation (S400), only the cleaning container C10 may be cleaned.

During the operation (S400), the supply of the cleaning liquid TH through the cleaning liquid supply portion C20 and the discharge of the cleaning liquid TH through the discharge portion C12 may be performed simultaneously and continuously. In this case, as described above, the preset first supply amount of cleaning liquid TH may be supplied, and thus an amount of cleaning liquid being discharged by the discharge portion C12 may be adjusted to an amount, the same as or similar to the preset first supply amount. Accordingly, during the operation (S400), the cleaning liquid TH may be maintained at the first liquid level ha.

Referring to FIG. 9D, the first discharge operation (S400a) in which the cleaning liquid TH in the accommodation space C11 is externally discharged may be performed. More specifically, after the first cleaning operation (S400) is completed, in the operation (S400a, the cleaning liquid TH filled in the accommodation space C11 may be fully discharged through the discharge portion C12. To this end, in the operation (S400a, only the discharge of the cleaning liquid TH may be performed in a state in which the supply of the cleaning liquid TH through the cleaning liquid supply portion C20 is stopped. As the cleaning liquid TH is discharged, the accommodation space C11 may be in an almost empty state in which the cleaning liquid TH is not filled.

As described above, the operations (S100 to S400) and the operation (S400a) may be performed at the same position (that is, a sucking position) in a state in which the spraying portion 920 is further raised or lowered.

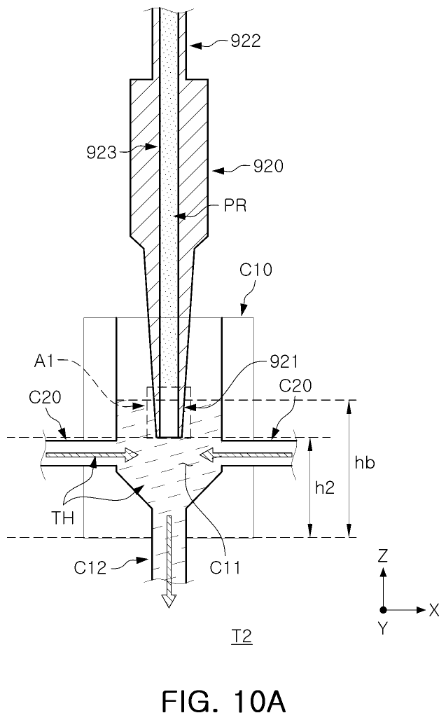

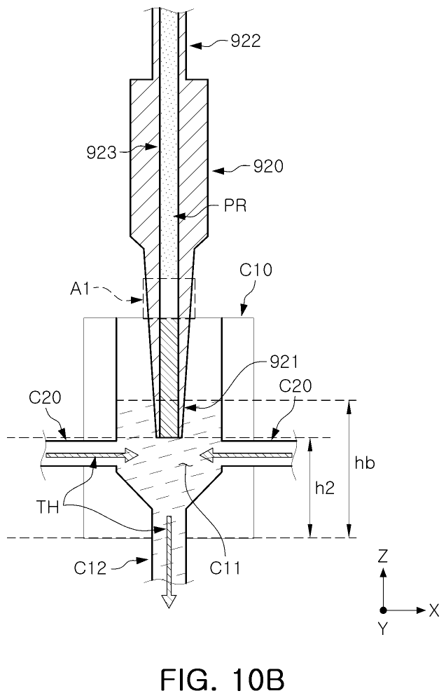

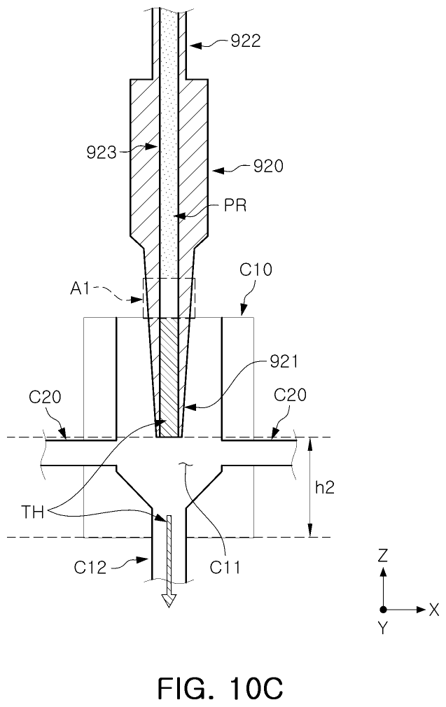

FIG. 10A is a schematic cross-sectional view of another operation of a method of cleaning the treatment liquid coating apparatus of FIG. 7. FIG. 10B is a schematic cross-sectional view of another operation of a method of cleaning the treatment liquid coating apparatus of FIG. 7. FIG. 10C is a schematic cross-sectional view of another operation of a method of cleaning the treatment liquid coating apparatus of FIG. 7.

Referring to FIG. 10A, the second cleaning operation (S500) of cleaning the nozzle tip 921 of the spraying portion 920 may be performed. To this end, the cleaning liquid TH may be supplied back to the accommodation space C11. The cleaning liquid TH may be, for example, a thinner, as in the operation (S400). In this case, the second cleaning operation (S500) may be performed in the sucking position, as in the operations described above. That is, the operation (S500) may be performed in the sucking position without raising or lowering a spraying portion 920.

More specifically, the cleaning liquid TH may be sprayed into the accommodation space C11 through the cleaning liquid supply portion C20. In the operation (S500), a “preset second supply amount” of cleaning liquid TH may be supplied and sprayed.

The preset second supply amount may be adjusted to an amount different from the supply amount (that is, the preset first supply amount) in the first cleaning operation (S400). The operation (S500), an operation for cleaning the nozzle tip 921 disposed at a height, higher than the first water level ha described above, such that the preset second supply amount may be greater than the preset first supply amount. The preset second supply amount may be the same as or similar to an amount that is twice the preset first supply amount, but the present disclosure is not limited thereto. That is, the preset second supply amount may be changed according to an internal volume of the accommodation space C11 and/or a height at which the nozzle tip 921 is disposed.

As the cleaning liquid TH is supplied again, the cleaning liquid TH may be filled in the accommodation space C11 to reach a second water level hb. Accordingly, the cleaning liquid TH may be filled in the accommodation space C11 at the second water level hb. In this case, the preset second supply amount of cleaning liquid TH, greater than the preset first supply amount of cleaning liquid TH, may be supplied, such that the second water level hb may be higher than the first water level ha. As described, a state in which the cleaning liquid TH is filled again is defined as a “second filling state T2.”

In addition, when the second filling state T2 is reached, the “second water level hb,” a liquid level of the cleaning liquid TH filled in the accommodation space C11, may be higher than the “second height h2,” a height of an end of the nozzle tip 921. That is, in the second filling state T2, at least a portion (for example, an end) of the nozzle tip 921 may be immersed in the cleaning liquid TH. Accordingly, in the second cleaning operation (S500), the nozzle tip 921 may be cleaned.

During the operation (S500), the supply of the cleaning liquid TH through the cleaning liquid supply portion C20 and the discharge of the cleaning liquid TH through the discharge portion C12 may be performed simultaneously and continuously. In this case, as described above, the preset second supply amount of cleaning liquid TH may be supplied, and thus an amount of cleaning liquid being discharged by the discharge portion C12 may be adjusted to an amount, the same as or similar to the preset second supply amount. Accordingly, during the operation (S500), the cleaning liquid TH may be maintained at the second liquid level hb.

Referring to FIG. 10B, a second suck-back operation (S600) of suck-backing the treatment liquid PR further backwards than in the first suck-back operation (S200) (hereinafter, referred to as second suck-back SB2) may be performed. In this case, the second suck-back SB2 may be performed in the sucking position.

More specifically, the suck-back portion 940 may suck the treatment liquid PR remaining in the spraying portion 920, such that the treatment liquid PR may be moved further backwards than in the first suck-back operation (S200) (hereinafter, the second suck-back operation) (S500). Accordingly, the treatment liquid PR moved backwardly in the operation (S200) described above may be sucked further backwardly (+Z) than in the first suck-back SB1.

In addition, the second suck-back SB2 may be performed in the second filling state T2. Thus, while the above-described treatment liquid PR is sucked and moved backwardly, a portion of the cleaning liquid TH filled through the outlet 921a of the nozzle tip 921 may be sucked into the discharge flow path 923. Accordingly, the treatment liquid PR moved backwardly may be present in an internal upper portion of the discharge flow path 923. In addition, the sucked cleaning liquid TH may be present in an internal lower portion of the discharge flow path 923. In this case, the first air layer A1 may be present between the treatment liquid PR and the cleaning liquid TH in the discharge flow path 923. As described, the cleaning liquid TH sucked into the nozzle tip 921 may be mixed with the treatment liquid PR remaining in the discharge flow path 923 of the nozzle tip 921, thereby lowering viscosity of the treatment liquid PR. Accordingly, the outlet 921a may be prevented from being blocked due to the treatment liquid PR being cured in the discharge flow path 923.

The second suck-back operation (S500) may be started after the above-described second cleaning operation (S400) is performed for a “preset period of time.” Here, the preset time may be a period of time sufficient for foreign substances separated from the nozzle tip 921 by the second cleaning operation (S400) to be discharged through the discharge portion C12 together with the cleaning liquid TH used for cleaning. In this case, for example, after the foreign substances separated from the nozzle tip 921 are fully discharged to the outside of the accommodation space C11, the second suck-back operation (S500) may be start, thereby preventing the foreign substances from being introduced into the inside of the spraying portion 920 (that is, the discharge flow path 923) during the second suck-back SB2.

Referring to FIG. 10C, the second discharge operation (S600a) of externally discharging the cleaning liquid TH in the accommodation space C11 may be performed. More specifically, after the second suck-back operation (S600) is completed, in the operation (S600a), the cleaning liquid TH filled in the accommodation space C11 may be fully discharged through the discharge portion C12. To this end, in the operation (S600a), only the discharge of the cleaning liquid TH may be performed in a state in which the supply of the cleaning liquid TH through the cleaning liquid supply portion C20 is stopped. As the cleaning liquid TH is discharged, the accommodation space C11 may be in an almost empty state in which the cleaning liquid TH is not filled.

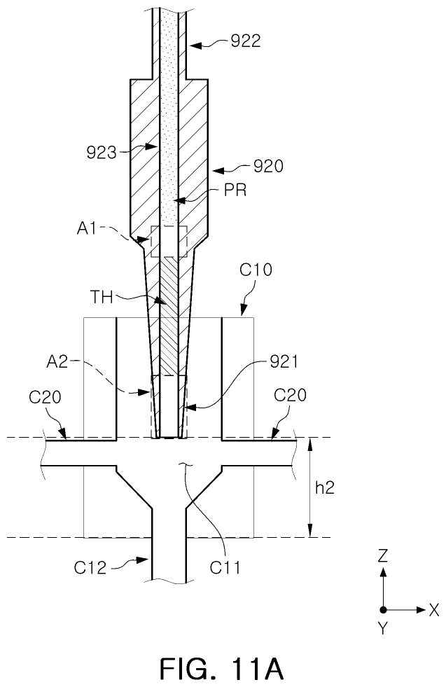

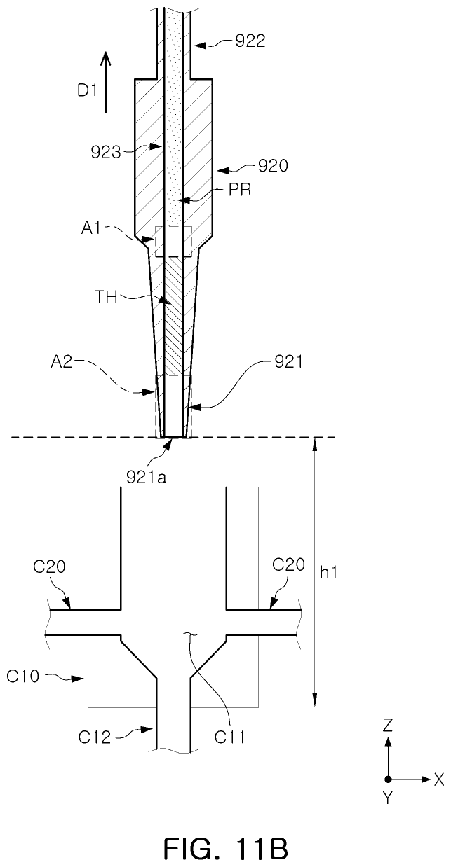

FIG. 11A is a schematic cross-sectional view of another operation of a method of cleaning the treatment liquid coating apparatus of FIG. 7. FIG. 11B is a schematic cross-sectional view of another operation of a method of cleaning the treatment liquid coating apparatus of FIG. 7.

Referring to FIG. 11A, a third suck-back operation (S700) of suck-backing the suck-backed treatment liquid PR further backwards than in the second suck-back operation (S600) (hereinafter, referred to as third suck-back SB3) may be performed. In this case, the third suck-back operation (S700) may be performed in the sucking position as in the operations described above.

More specifically, before the operation (S700) is started, the discharge of the second suck-back SB2 and the cleaning liquid TH may be completed in the operations (S500) and (S600a). That is, the third suck-back operation (S700) may be performed in a state in which the cleaning liquid TH is not filled in the accommodation space C11. The third suck-back SB3 may be performed in such a state, such that the cleaning liquid TH and the treatment liquid PR sucked in the operation (S600) may be sucked and moved backwardly (+Z) once again.

In this case, the operation (S700) may be performed in a state in which the accommodation space C11 is almost empty, such a portion of the air in the accommodation space C11 may be sucked into the discharge flow path 923 by the third suck-back SB3. Accordingly, a “second air layer A2” in which the cleaning liquid TH and the treatment liquid PR are hardly present may be formed in the discharge flow path 923 inside the outlet 921a. The second air layer A2 may prevent foreign substances from being introduced into the nozzle tip 921 through the outlet 921a. In addition, the cleaning liquid TH may be positioned between the treatment liquid PR and the second air layer A2 in the discharge flow path 923, thereby preventing the treatment liquid PR from being cured by the second air layer A2.

Referring to FIG. 11B, when the third suck-back operation (S700) is completed, the spraying portion 920 may return to an original position thereof (S800). In this case, the spraying portion 920 may be raised in the direction D1 by the transfer unit S and return to the initial position described above. Accordingly, the nozzle tip 921 of the spraying portion 920 may be withdrawn upwardly from the accommodation space C11 of the cleaning container C10. Thereafter, the spraying portion 920 may be transferred to an upper portion of the treatment container 411 by the transfer unit S to perform a subsequent substrate treatment process. A process of coating the treatment liquid PR on the substrate W using the spraying portion 920 and a process of cleaning the spraying portion 920 and the cleaning unit CU may be repeatedly performed while the entire substrate treatment process is performed.

As described above, in the treatment liquid coating apparatus 900 and the treatment liquid coating apparatus cleaning method (S10) according to the present disclosure, all operations (S200, S300, S400, S500, S600, and S700), after the spraying portion 920 moves to the sucking position, may be performed in the same position (sucking position) without additional position change.

In addition, the cleaning container C10 and the nozzle tip 921 may be sequentially cleaned (the first and second cleaning operations (S400 and S500)). The cleaning liquid TH used in such a process may be fully discharged, and then a contamination prevention layer (a second air layer A2) may be formed in the spraying portion 920 to prevent foreign substances from being introduced into the nozzle tip 921 during the cleaning process.

The above example embodiments have been described in which a substrate treatment apparatus of the present disclosure is applied to a photo process, but the present disclosure is not limited thereto. As long as the substrate treatment apparatus is usable as an apparatus for removing fumes generated in the process of heating a substrate, it will be obvious to those skilled in the art that the substrate treatment apparatus is applicable to various processes such as an etching process, a testing process, and a packaging process, which will also fall within the scope of the present disclosure.

While example embodiments have been shown and described above, it will be apparent to those skilled in the art that modifications and variations could be made without departing from the scope of the present disclosure as defined by the appended claims.

What is claimed is:

1. A method of cleaning a treatment liquid coating apparatus, the method comprising:
an operation of moving a spraying portion to a sucking position;
an operation of discharging, by the spraying portion, a treatment liquid to the inside of a cleaning container in the sucking position;
a first suck-back operation of suck-backing the treatment liquid remaining in the spraying portion;
a first cleaning operation of cleaning an accommodation space of the cleaning container by supplying a preset first supply amount of cleaning liquid;
a second cleaning operation of cleaning a nozzle tip of the spraying portion by supplying a preset second supply amount of cleaning liquid;
a second suck-back operation of suck-backing and moving the treatment liquid further backwards than in the first suck-back operation; and
a third suck-back operation of suck-backing and moving the suck-backed treatment liquid further backwards than in the second suck-back operation.

2. The method of claim 1, wherein, in the operation of moving the spraying portion to the sucking position, the spraying portion is lowered such that at least a portion of the nozzle tip is accommodated in the accommodation space.

3. The method of claim 1, wherein, in the first cleaning operation, the cleaning liquid is filled into the accommodation space to reach a first liquid level.

4. The method of claim 3, wherein, when the cleaning liquid is filled in the accommodation space at the first liquid level, the nozzle tip is spaced apart from the cleaning liquid.

5. The method of claim 3, further comprising:
a first discharge operation of discharging the cleaning liquid in the accommodation space, between the first cleaning operation and the second cleaning operation.

6. The method of claim 3, wherein, in the second cleaning operation, the cleaning liquid is filled into the accommodation space to reach a second liquid level, different from the first liquid level.

7. The method of claim 6, wherein the second liquid level is higher than the first liquid level.

8. The method of claim 7, wherein the second liquid level is twice the first liquid level.

9. The method of claim 6, wherein, when the cleaning liquid is filled in the accommodation space at the second liquid level, at least a portion of the nozzle tip is immersed in the cleaning liquid.

10. The method of claim 1, wherein the preset second supply amount is greater than the preset first supply amount.

11. The method of claim 1, further comprising:
a second discharge operation of externally discharging the cleaning liquid in the accommodation space, before the third suck-back operation.

12. The method of claim 1, wherein, in the second cleaning operation, the cleaning liquid is supplied into the accommodation space, and the cleaning liquid is discharged from the accommodation space.

13. The method of claim 12, wherein the second suck-back operation is started after the second cleaning operation is performed for a preset period of time.

14. The method of claim 1, wherein, in the second suck-back operation, a portion of the cleaning liquid is sucked into the spraying portion due to suck-back of the treatment liquid.

15. The method of claim 14, wherein, in the third suck-back operation, the sucked cleaning liquid and the sucked treatment liquid are sucked backwardly, such that an air layer is formed at an outlet of the nozzle tip and in the nozzle tip.

16. The method of claim 1, wherein the spraying portion is raised such that the nozzle tip is withdrawn from the accommodation space, after the third suck-back operation.

17. A treatment liquid coating apparatus comprising:
a spraying portion connected to a treatment liquid supply source through a supply line, the spraying portion including a nozzle tip from which the treatment liquid is discharged, and a discharge flow path extending at least partially from the inside of the nozzle tip;
a suck-back portion disposed on the supply line, the suck-back portion positioned between the treatment liquid supply source and the spraying portion, the suck-back portion suck-backing the treatment liquid remaining in the discharge flow path;
a cleaning unit disposed on a lower side of the spraying portion, the cleaning unit including a cleaning container having an open upper portion, the cleaning container having an accommodation space therein, a cleaning liquid supply portion connected to the cleaning container and supplying the cleaning liquid to the accommodation space, and a discharge portion disposed at a lower end of the cleaning container, the discharge portion communicating with the accommodation space to discharge the cleaning liquid; and
a transfer unit connected to the spraying portion, the transfer unit raising and lowering the spraying portion such that the nozzle tip is at least partially accommodated in the accommodation space or the nozzle tip is withdrawn from the accommodation space,
wherein the cleaning liquid supply portion is disposed between the nozzle tip and the discharge portion to supply the cleaning liquid into the accommodation space when the nozzle tip is accommodated in the accommodation space, supplies a preset first supply amount of cleaning liquid when the cleaning container is cleaned, and supplies a preset second supply amount of cleaning liquid, greater than the preset first supply amount of cleaning liquid, when the nozzle tip is cleaned.

18. The treatment liquid coating apparatus of claim 17, wherein
the cleaning container and the nozzle tip are cleaned in a state in which the spraying portion is disposed in the same position, and
the nozzle tip is spaced apart from the cleaning liquid when the preset first supply amount of cleaning liquid is supplied into the accommodation space, and at least a portion of the nozzle tip is immersed in the cleaning liquid when the preset second supply amount of cleaning liquid is supplied into the accommodation space.

19. The treatment liquid coating apparatus of claim 18, wherein the suck-back portion sucks-back a portion of the cleaning liquid filled in the accommodation space, and the treatment liquid remaining in the discharge flow path, after a preset period of time has elapsed after the nozzle tip is cleaned.

20. A method of cleaning a treatment liquid coating apparatus, the method comprising:
an operation of lowering a spraying portion to a sucking position such that at least a portion of a nozzle tip of the spraying portion is accommodated in an accommodation space of a cleaning container;
an operation of discharging, by the spraying portion, a treatment liquid into the accommodation space in the sucking position;
a first suck-back operation of suck-backing the treatment liquid remaining in the spraying portion;
a first cleaning operation of cleaning the accommodation space of the cleaning container by supplying a preset first supply amount of cleaning liquid;
a second cleaning operation of cleaning a nozzle tip of the spraying portion by supplying a preset second supply amount of cleaning liquid, greater than the preset first supply amount of cleaning liquid;
a second suck-back operation of suck-backing and moving the treatment liquid further backwards than in the first suck-back operation;
a third suck-back operation of suck-backing and moving the suck-backed treatment liquid further backwards than in the second suck-back operation;
a first discharge operation of discharging the cleaning liquid in the accommodation space, between the first cleaning operation and the second cleaning operation;
a second discharge operation of externally discharging the cleaning liquid in the accommodation space, before the third suck-back operation; and
an operation of raising the spraying portion to return to an original position thereof, after the third suck-back operation,
wherein, in the first cleaning operation, when the cleaning liquid is filled into the accommodation space to reach a first liquid level and filled in the accommodation at the first liquid level, an end of the nozzle tip is spaced apart from the cleaning liquid not to be in contact with the cleaning liquid, and
in the second cleaning operation, when the cleaning liquid is filled into the accommodation space to reach a second liquid level, higher than the first liquid level, and filled in the accommodation at the second liquid level, at least a portion of the nozzle tip is immersed in the cleaning liquid.
